(19) United States
(12) Patent Application Publication
(10) Pub. No.: US 2024/0420428 A1
(43) Pub. Date: Dec. 19, 2024

(54) AUGMENTED REALITY DISPLAY DEVICE

(71) Applicant: Sharp Display Technology Corporation, Kameyama City (JP)

(72) Inventor: Naru USUKURA, Kameyama City (JP)

(21) Appl. No.: 18/643,505

(22) Filed: Apr. 23, 2024

(30) Foreign Application Priority Data
Jun. 13, 2023 (JP) 2023-097117

(51) Int. Cl. G06T 19/00; G02B 5/08; G02B 5/30

(52) U.S. Cl. CPC G06T 19/006; G02B 5/08; G02B 5/30

(57) ABSTRACT

An augmented reality display device causes a user to perceive first and second images at different distances in a state where the user can perceive a real environment. The augmented reality display device includes: a display panel which emits polarized lights for first and second images; a surface-divided polarization conversion component; and an optical element and a concave semi-transparent mirror. The surface-divided polarization conversion component in a plan view includes: a first transmissive part; and a second transmissive part which introduces a phase difference different by λ/2 from a phase difference introduced by the first transmissive part. The optical element makes a first image generated from the first polarized light transmitted through the first transmissive part different in virtual image distance from a second image generated from the second polarized light transmitted through the second transmissive part.

### CROSS-REFERENCE TO RELATED APPLICATIONS

The present application claims priority under 35 U.S.C. § 119 to Japanese Patent Application No. 2023-097117 filed on Jun. 13, 2023, the contents of which are incorporated herein by reference in their entirety.

### BACKGROUND OF THE INVENTION

### Field of the Invention

The following disclosure relates to augmented reality display devices.

### Description of Related Art

Research and development have recently advanced on augmented reality display devices, which superimpose images (also called “video”) on the real world. For example, head-up displays that display images of information for the driver on the windshield have been suggested. Such augmented reality display devices sometimes use three-dimensional images as images to be superimposed on the real world to enhance the sense of realism.

A technique relating to three-dimensional display is disclosed in, for example, JP 2002-156603 A. The technique disclosed is a three-dimensional display method including generating a two-dimensional image by projecting from the gaze directions of the viewer's eyes an object to be displayed onto multiple display surfaces arranged at different depth positions as seen from a viewer, displaying the generated two-dimensional image on each of any two display surfaces among the multiple display surfaces, and varying the luminance values of the displayed two-dimensional images on the individual two display surfaces among the multiple display surfaces independently to generate a three-dimensional stereoscopic image, wherein polarization-type multifocal optics is used to form images of the display light for a two-dimensional image on the individual two display surfaces among the multiple display surfaces while the polarization direction of the display light is controlled to independently vary the luminance values of the two-dimensional images formed on the individual two display surfaces among the multiple display surfaces.

### BRIEF SUMMARY OF THE INVENTION

The conventional art disclosed in JP 2002-156603 A can provide three-dimensional display seen with the naked eyes, but is not applicable to augmented reality display devices.

In response to the above issues, an object of the present invention is to provide an augmented reality display device with an enhanced sense of realism of display images.
(1) One embodiment of the present invention is directed to an augmented reality display device causing a user to perceive a first image and a second image at different distances in a state where the user can perceive a real environment, the augmented reality display device including: a display panel configured to emit polarized light for a first image and polarized light for a second image; a surface-divided polarization conversion component placed at a position where the polarized lights enter; and an optical element and a concave semi-transparent mirror, each being placed at a position where the polarized lights transmitted through the surface-divided polarization conversion component enter, the surface-divided polarization conversion component in a plan view including: a first transmissive part which transmits polarized light for a first image; and a second transmissive part which transmits polarized light for a second image and introduces a phase difference different by λ/2 from a phase difference introduced by the first transmissive part, the optical element being configured to make a virtual image distance of a first image generated from the first polarized light transmitted through the first transmissive part different from a virtual image distance of a second image generated from the second polarized light transmitted through the second transmissive part.
(2) In an embodiment of the present invention, the augmented reality display device includes the structure (1), the first transmissive part is a non-conversion part that transmits polarized light for a first image without converting a polarization state of the polarized light, and the second transmissive part is a conversion part that converts a polarization state of polarized light for a second image by introducing a phase difference of λ/2 to the polarized light for a second image.
(3) In an embodiment of the present invention, the augmented reality display device includes the structure (2), and the conversion part includes a resin layer with a phase difference of λ/2.
(4) In an embodiment of the present invention, the augmented reality display device includes the structure (1), (2), or (3), the second transmissive part in a cross-sectional view includes a pair of substrates and a liquid crystal layer placed between the pair of substrates, and the second transmissive part introduces a phase difference that is variable depending on voltage applied to the liquid crystal layer.
(5) In an embodiment of the present invention, the augmented reality display device includes the structure (1), (2), (3), or (4), the optical element is a liquid crystal lens, and the liquid crystal lens acts as a lens with a first focal length for the first polarized light and does not act as a lens or acts as a lens with a second focal length for the second polarized light.
(6) In an embodiment of the present invention, the augmented reality display device includes the structure (5), and the liquid crystal lens is a refractive lens, a gradient-index lens, or a diffractive lens.
(7) In an embodiment of the present invention, the augmented reality display device includes the structure (5), and the liquid crystal lens is a Pancharatnam-Berry phase lens.
(8) In an embodiment of the present invention, the augmented reality display device includes the structure (5), and the liquid crystal lens includes a liquid crystal layer and has a focal length that is variable depending on voltage applied to the liquid crystal layer.
(9) In an embodiment of the present invention, the augmented reality display device includes the structure (1), (2), (3), (4), (5), (6), (7), or (8), and further includes a polarization selective reflector placed at a position where the polarized lights transmitted through the surface-divided polarization conversion component enter.
(10) In an embodiment of the present invention, the augmented reality display device includes the structure (1), (2), (3), (4), (5), (6), (7), (8), or (9), and further includes a combination of an additional surface-divided polarization conversion component and an additional liquid crystal lens.
(11) In an embodiment of the present invention, the augmented reality display device includes the structure (1), (2), (3), (4), (5), (6), (7), (8), (9), or (10), which is a head-mounted display device.

The present invention can provide an augmented reality display device with an enhanced sense of realism of display images.

### BRIEF DESCRIPTION OF THE DRAWINGS

FIG. 1 shows the display principle of a virtual image in a display device.

FIG. 2 shows a conventional VR display principle.

FIG. 3 shows the state where the human eyes see an actual object.

FIG. 4 shows the display state in one virtual image plane.

FIG. 5 shows the display state in two virtual image planes.

FIG. 6 is a schematic side view of the configuration of an augmented reality display device of Embodiment 1.

FIG. 7 is an enlarged cross-sectional view of a surface-divided polarization conversion component in Embodiment 1.

FIG. 8 shows the structure of a refractive lens made of a resin, with the upper part showing a cross-sectional view and the lower part showing a top view.

FIG. 9 shows the operation of the refractive lens at an azimuth A indicated in FIG. 8, with the upper part showing the state with voltage applied to the liquid crystal layer and the lower part showing the state with no voltage applied to the liquid crystal layer.

FIG. 10 shows the operation of the refractive lens at an azimuth B indicated in FIG. 8, with the upper part showing the state with voltage applied to the liquid crystal layer and the lower part showing the state with no voltage applied to the liquid crystal layer.

FIG. 11 is a top view showing the configuration of a Pancharatnam-Berry phase lens.

FIG. 12 shows the functions of a Pancharatnam-Berry phase lens.

FIG. 13 is a side view schematically showing the configuration of an augmented reality display device of Embodiment 2.

FIG. 14 is a side view schematically showing an augmented reality display device of Embodiment 3.

FIG. 15 is a side view schematically showing another example of the configuration in the vicinity of a concave semi-transparent mirror in the augmented reality display device of Embodiment 3.

FIG. 16 is an explanatory view showing an example of images displayed by an augmented reality display device, with the left part showing the original image and the right part showing an enlarged image.

FIG. 17 is an explanatory view showing an example in which display images displayed by an in-vehicle augmented reality display device are superimposed on the real environment.

FIG. 18 is a plan view schematically showing the configuration of a surface-divided polarization conversion component in an augmented reality display device of Embodiment 4.

### DETAILED DESCRIPTION OF THE INVENTION

The following describes some embodiments of the present invention. The present invention is not limited to the following embodiments. The design may be modified as appropriate within the range satisfying the configuration of the present invention. In the following description, components having the same or similar functions in different drawings are commonly provided with the same reference sign so as to appropriately avoid repetition of description. The structures in the present invention may be combined as appropriate without departing from the gist of the present invention.

The augmented reality display devices of the present embodiments cause the user to perceive a first image and a second image at different distances in a state where the user can perceive the real environment. The display devices may be of any type and may be, for example, augmented reality (AR) display devices which display the content compatible with the AR technology or head-up displays (HUDs).

The display devices may be in any form and may be, for example, head-mounted display devices (HMDs). A head-mounted display device (HMD) is a display device in a head-wearable form and, for example, has the shape of goggles to be worn on the head of the user such that a display such as a liquid crystal display comes in front of the eyes of the user when it is worn. Such an HMD is suitable for viewing the content compatible with the augmented reality (AR) technology. Examples of the configuration of an HMD include one having a support for wearing on the head of the user and a display with a liquid crystal module, wherein the display comes in front of the eyes of the user when the device is worn.

The augmented reality display devices of the present embodiments include a surface-divided polarization conversion component and thus can generate two images at different virtual image distances using one display panel. Specific examples of application include application to an AR display device so that the device can add images of a close view (close virtual image) and a distant view (distant virtual image) to the real world. This can enhance the sense of realism of display images, thus easing the burden on the user (viewer) during viewing or enhancing the sense of immersion into the content.

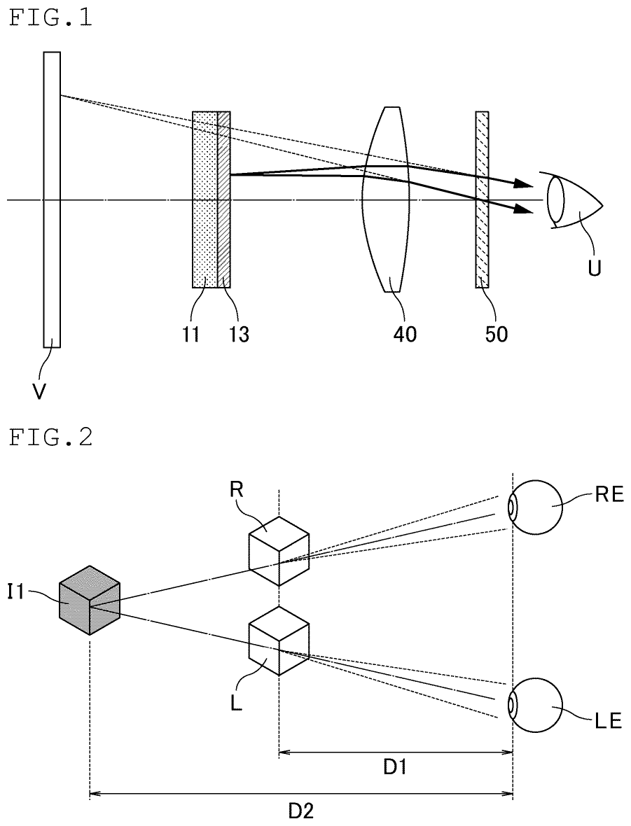

FIG. 1 shows the display principle of a virtual image in a display device. In the attached drawings, a dashed and dotted line indicates the gaze direction of a user U's eyes, a solid line arrow indicates the path of light for displaying a real image traveling toward the user U's eyes, and a dotted line arrow indicates the path of light for displaying a virtual image traveling toward the user U's eyes.

The display device in FIG. 1 includes, sequentially from the user U side, a liquid crystal lens 50 whose focal length is adjustable, a lens (physical lens) 40 whose focal length is constant, a polarizing plate 13, and a display 11. In cases of a device such as a head-mounted display device (HMD), the distance from the liquid crystal lens 50 to the display 11 is short, so that the user U perceives a virtual image V behind the display 11. Varying the focal length of the liquid crystal lens 50 moves the position of the virtual image V closer to or away from the user U. Whether the virtual image V moves intermittently or continuously depends on the system of the liquid crystal lens 50. In the display device in FIG. 1, the virtual image V, displayed at a specific timing, is formed only at a specific distance. In other words, the virtual image V is displayed in one plane. Hereinafter, the plane in which the virtual image V is displayed is also referred to as a “virtual image plane”.

Next, issues in use of virtual images for display are described based on a VR display device which is a typical example of a display device that uses virtual images for display. Known issues include VR motion sickness, which is caused by the following mechanism.

FIG. 2 shows a conventional VR display principle. As shown in FIG. 2, VR display separately displays an image R intended for the right eye and an image L intended for the left eye to cause the user U to perceive an image I1 at the position where a 3D image is intended to be displayed. FIG. 3 shows the state where the human eyes see an actual object. As is understood from the comparison between FIGS. 2 and 3, the conventional VR creates a state different from the state where the human eyes see an actual object in that the movement where the right eye RE and the left eye LE rotate toward an image I1 (convergence) is inconsistent with the focus adjustment. VR motion sickness is considered to occur due to the difference between the distance of focus adjustment (distance to the image R intended for the right eye and distance to the image L intended for the left eye), D1, and the distance to the eyes' gaze point, D2. This is because the image R intended for the right eye and the image L intended for the left eye are virtual images and thus the virtual image planes (virtual image distances) cannot be moved. When the virtual image planes can be moved using a liquid crystal lens whose focal length is adjustable, for example, the state shown in FIG. 3 can be achieved, so that the VR motion sickness can be prevented.

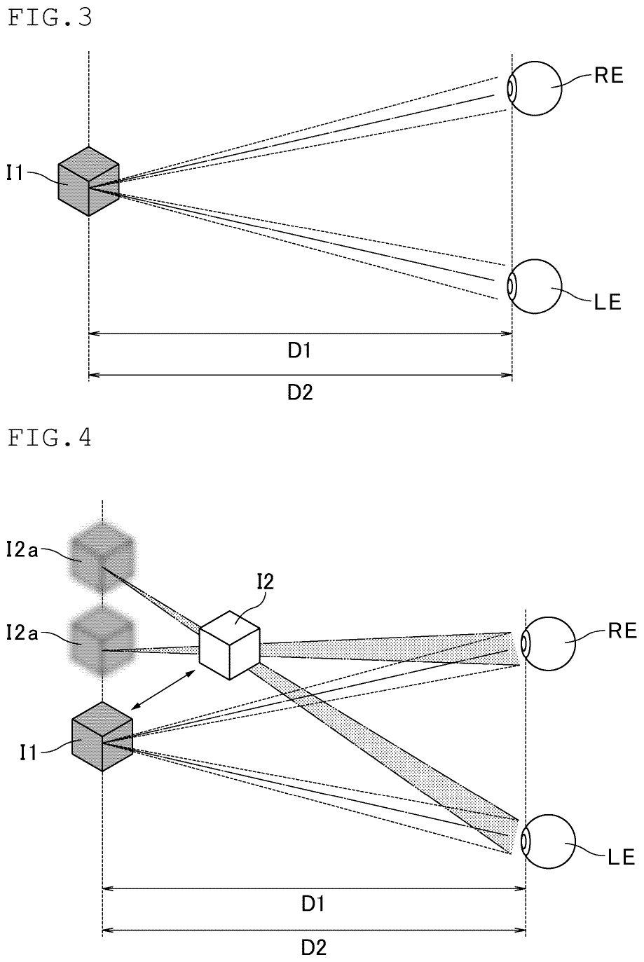

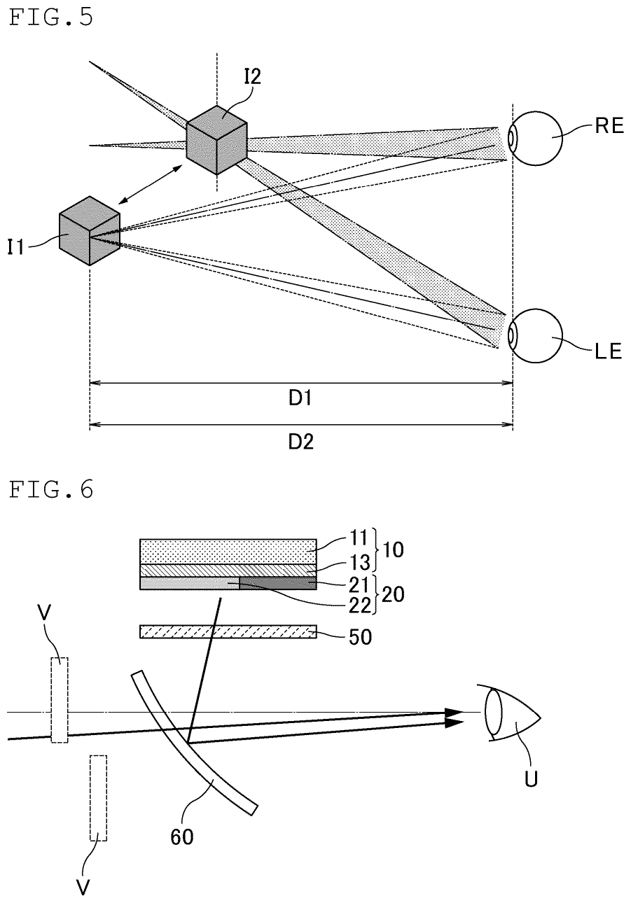

Meanwhile, in displaying an image with a stereoscopic effect (3D image) by the VR technology, as compared to the state where one sees an actual object, it is difficult to completely eliminate the uncomfortable feeling by simply moving the virtual images using a liquid crystal lens whose focal length is adjustable, for example. FIG. 4 shows the display state in one virtual image plane. FIG. 5 shows the display state in two virtual image planes. When there is only one virtual image plane, how to express the objects in the peripheral vision is the problem. Specifically, as shown in FIG. 4, when one's eyes focus on the position of the image I1, then an image I2, which is an object at a closer position, should appear blurred. With one virtual image plane, two blurred images 12a for the right eye and the left eye can be displayed in one virtual image plane to cause the viewer to perceive a blurred image I2, thus making the viewer feel that the image I2 is in the peripheral vision. In this case, however, both liquid crystal lenses and the images need switching when the gaze point is switched between the position of the image I1 and the position of the image I2, and it is difficult to completely eliminate the uncomfortable feeling in seeing the blurry state expressed using images. In contrast, with two virtual image planes as shown in FIG. 5, there is no need to switch the liquid crystal lenses and the images in gaze switching between the positions, allowing smooth gaze switching and a favorable sense of immersion. The present invention thus generates two virtual image planes (two images at different virtual image distances).

### Embodiment 1

FIG. 6 is a schematic side view of the configuration of an augmented reality display device of Embodiment 1. An augmented reality display device of Embodiment 1 is an AR display device. An AR display device uses components such as a concave lens (concave semi-transparent mirror) 60 and a light guide plate to cause the user U to view images from the display 11 superimposed on the real environment. The concave semi-transparent mirror 60 transmits ambient light toward the user U and reflects the image light from the display 11 toward the user U. The AR display device sequentially includes the liquid crystal lens (optical element) 50 whose focal length is adjustable, a surface-divided polarization conversion component 20, the polarizing plate 13, and the display 11, which are disposed opposite to the reflection surface of the concave semi-transparent mirror 60.

The display 11 and the polarizing plate 13 in combination define a display panel 10 which emits polarized light. When one of the two images at different virtual image distances is defined as a “first image” and the other as a “second image”, the display panel emits polarized light for a first image and polarized light for a second image. The polarized light for a first image and the polarized light for a second image are transmitted through the surface-divided polarization conversion component 20 to enter the liquid crystal lens 50 whose focal length is adjustable.

Examples of the display 11 include liquid crystal display devices (LCDs) and self-luminous displays such as organic EL display devices (OLEDs). The polarizing plate 13 used is a linear polarizer which transmits polarized light (first polarized light component) vibrating in a certain one direction and absorbs or reflects polarized light (second polarized light component) vibrating in a direction orthogonal to the certain one direction.

The surface-divided polarization conversion component 20 in a plan view includes a first transmissive part which transmits polarized light for a first image and a second transmissive part which transmits polarized light for a second image. The second transmissive part is a region that introduces a phase difference different by λ/2 from a phase difference introduced by the first transmissive part. When polarized light for a first image is transmitted through the first transmissive part and polarized light for a second image is transmitted through the second transmissive part, a phase difference of λ/2 can be introduced between the polarized light for a first image and the polarized light for a second image. The display device shown in FIG. 6 uses the phase difference, λ/2 , to make the virtual image distances of the two images different. When “a phase difference of λ/2” is introduced, this means that a phase difference corresponding to half a wavelength of light transmitted is introduced to the light; for example, a phase difference of 200 nm or more and 350 nm or less is introduced to light with a wavelength of 550 nm.

In the present embodiment, the surface-divided polarization conversion component 20 is a component in which the first transmissive part is a non-conversion part 22 which transmits polarized light for a first image with no change in the polarization state and the second transmissive part is a conversion part 21 which introduces a phase difference of λ/2 to polarized light for a second image to change the polarization state of the light. The expression “with no change in the polarization state” means that, for example, the phase difference to be introduced to light with a wavelength of 550 nm is 10 nm or less.

The surface-divided polarization conversion component 20 can be one that variably forms two or more parts introducing phase differences different by λ/2 from each other in a plane parallel to the display surface of the display 11. For example, a liquid crystal panel can be used. In other words, in the surface-divided polarization conversion component 20, the conversion part (second transmissive part) 21 in a cross-sectional view includes a pair of substrates and a liquid crystal layer placed between the pair of substrates, and may introduce a phase difference variable depending on the voltage applied to the liquid crystal layer. In a configuration where two or more parts introducing phase differences different by λ/2 from each other are formed, the arrangement of the conversion part (second transmissive part) 21 and the non-conversion part (first transmissive part) 22 in the plane is switchable (ON/OFF) with time. Specifically, when voltage is applied to the liquid crystal layer, a region functioning as the conversion part 21 at a certain time point becomes the non-conversion part 22, and a region functioning as the non-conversion part 22 at the certain time point becomes the conversion part 21. Thus, preferably, the entirety of the surface-divided polarization conversion component 20 is a liquid crystal panel.

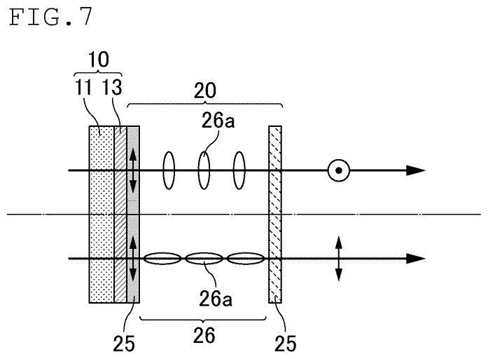

FIG. 7 is an enlarged cross-sectional view of a surface-divided polarization conversion component in Embodiment 1. The surface-divided polarization conversion component (liquid crystal panel) 20, which can switch between introducing or not introducing a phase difference of λ/2 (i.e., 275 nm to light with a wavelength of 550 nm) is placed on the screen of the display 11. The liquid crystal panel can be in a liquid crystal mode commonly used in liquid crystal panels, such as the TN mode, the VA mode, the ECB mode, the IPS mode, or the FFS mode. In an example in the VA mode, a configuration can be employed in which no phase difference is introduced in the voltage-off state and a phase difference of λ/2 is introduced in the voltage-on state. The surface-divided polarization conversion component 20 may be a stack of two liquid crystal panels to reduce wavelength dependence.

As shown in FIG. 7, the surface-divided polarization conversion component (liquid crystal panel) 20 can drive molecules of a liquid crystal 26a in each region in the liquid crystal layer 26 by applying voltage to the liquid crystal layer 26 held between the pair of substrates 25. The number of regions in the liquid crystal panel constituting the surface-divided polarization conversion component 20 may be equal to or less than the number of pixels in the display 11 overlaid therewith. FIG. 7 shows a VA-mode liquid crystal panel with the upper part in the voltage-on state and the lower part in the voltage-off state.

The linearly polarized light emitted from the display 11 undergoes no change in phase when transmitted through the surface-divided polarization conversion component 20 in the voltage-off state to thus emerge as the same linearly polarized light. Although the orientation of the liquid crystal lens 50 is not limited, a case is described where the liquid crystal lens 50 is placed not to act as a lens. In this case, transmitted light reaches the human eye in the same state as when emitted from the display, so that the screen of the display 11 is observed as is (the real image is observed).

When voltage application by the surface-divided polarization conversion component 20 is turned on, light emitted from the display 11 is converted to linearly polarized light with its vibration direction rotated 90 degrees. In this case, the liquid crystal lens 50 acts as a lens when the linearly polarized light is transmitted therethrough. Since the display 11 is placed at the distance equal to the focal length of the liquid crystal lens 50, the lens action makes the linearly polarized light into almost parallel light, which then reaches the user U's eyes. Thus, the display 11 appears to be almost at infinity to the user U (the user U sees the virtual image).

As described above, since the surface-divided polarization conversion component 20 can be used to switch between the real image and the virtual image, two virtual image planes at different distances can be viewed at the same time owing to the surface division, so that display with depth (3D display) can be viewed. For example, a character display region intended to be the foreground may be set as the non-conversion part 22 (region with a phase difference of zero) and the background region to be a distant view may be set as the conversion part 21 (region with a phase difference of λ/2).

In the configuration above, for simplification, the display 11 is placed at the focal length and the virtual image is set at infinity. The focal length of the liquid crystal lens 50 or the distance from the liquid crystal lens 50 to the display 11 can be changed to set the virtual image at the desired position. Since the focal length of the liquid crystal lens 50 can be adjusted by voltage, increasing the voltage applied to the liquid crystal lens 50 can also move the virtual image distance from infinity toward the user.

The surface-divided polarization conversion component 20 can be one steadily including two or more parts with phase differences different by λ/2 from one another in a plane parallel to the display surface of the display 11, such as a surface-divided component in which the non-conversion part 22 is a transparent component and the conversion part 21 is a λ/2 plate. The λ/2 plate is a component that introduces a phase difference corresponding to half the wavelength of visible light to the visible light, such as a component that introduces a phase difference of 200 nm or more and 350 nm or less to light with a wavelength of 550 nm. When a λ/2 plate is used, the arrangement of the conversion part (second transmissive part) 21 and the non-conversion part (first transmissive part) 22 in the plane is not switched (ON/OFF) with time.

The surface-divided component can be produced, for example, by a method including attaching a resin film with a phase difference of λ/2 to the entire surface of a support component such as a glass substrate, and patterning the resin film to leave the resin film in the conversion part 21, thus forming a resin layer. Alternatively, the surface-divided component may be produced by a method including attaching a resin film with a phase difference of λ/2 only to a region of a support component corresponding to the conversion part 21. Also, instead of a resin film with a phase difference of λ/2, a resin layer with a phase difference of λ/2 may be formed on a support component. For example, a method may be used including forming an alignment film on a support component, forming a layer made of a photopolymerizable liquid crystal material on the alignment film, and curing the photopolymerizable liquid crystal material into a resin layer.

At a position where the polarized lights transmitted through the surface-divided polarization conversion component 20 enter, an optical element is placed that makes the virtual image distance of the first image generated from the first polarized light transmitted through the non-conversion part (first transmissive part) 22 different from the virtual image distance of the second image generated from the second polarized light transmitted through the conversion part (second transmissive part) 21. The optical element corresponds to the liquid crystal lens 50 whose focal length is adjustable in the present embodiment. The liquid crystal lens 50 acts as a lens with a first focal length for the first polarized light and does not act as a lens (does not bend the path of light) or acts as a lens with a second focal length for the second polarized light. For example, when the vibration direction of polarized light emitted from the display panel 10 matches the direction in which the liquid crystal lens 50 acts, the first polarized light transmitted through the non-conversion part 22 shows the virtual image V, and the second polarized light whose vibration direction is changed 90 degrees by the conversion part 21 is not affected by the liquid crystal lens 50 and thus shows the real image (display screen of the display panel). Thus, two virtual image distances (including cases where one of them is a real image distance) can be achieved using one display panel, so that a smooth gaze switching including the above-described peripheral vision can be achieved.

Ambient light, when affected by the liquid crystal lens 50, undesirably forms two different-sized images since the magnifications of the lens are different between an azimuth with a lens action and an azimuth with no lens action. Thus, the liquid crystal lens 50 is placed at a position where ambient light does not pass through the lens, and the concave semi-transparent mirror 60 is placed on the optical path of the liquid crystal lens 50 to face the user U side surface of the liquid crystal lens 50.

Non-limiting examples of the type of the liquid crystal lens 50 include refractive lenses, gradient-index (GRIN) lenses, and diffractive lenses. The gradient-index (GRIN) lenses are lenses that bend the path of light by the liquid crystal alignment. These liquid crystal lenses commonly act as a lens for linearly polarized light vibrating in one direction but do not act as a lens for linearly polarized light vibrating in the other direction. When the liquid crystal material is a curable material, the focal length of the liquid crystal lens is fixed. In contrast, when the liquid crystal material is movable, the focal length of the lens can be variable. The focal length can be controlled by voltage in the case of refractive lenses, by both voltage and liquid crystal alignment period in the case of gradient-index lenses, and by liquid crystal alignment period in the case of diffractive lenses. Preferably, the liquid crystal lens includes a liquid crystal layer and has a focal length variable depending on the voltage applied to the liquid crystal layer.

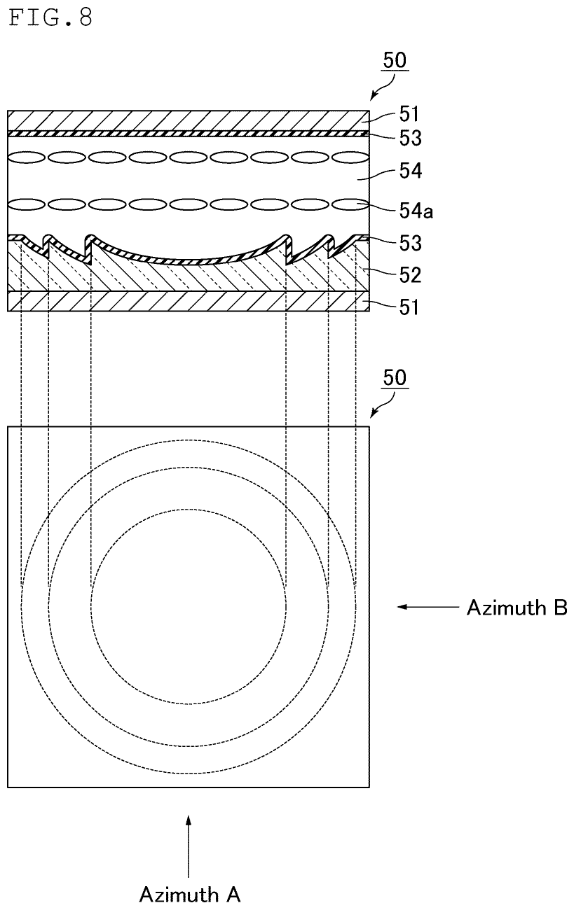

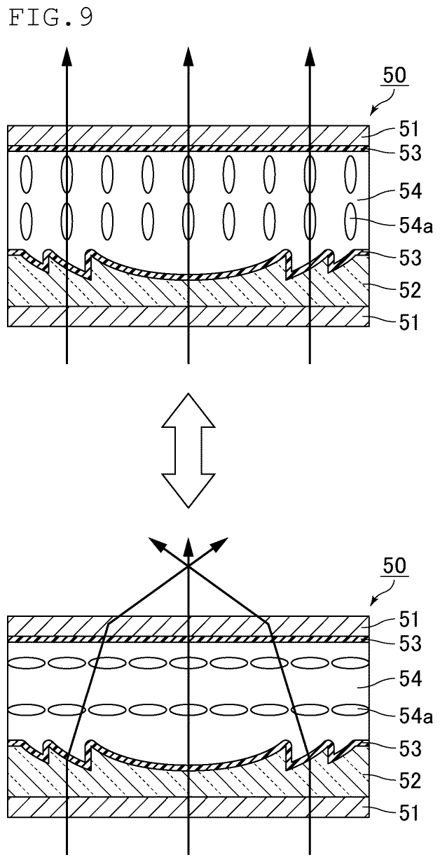

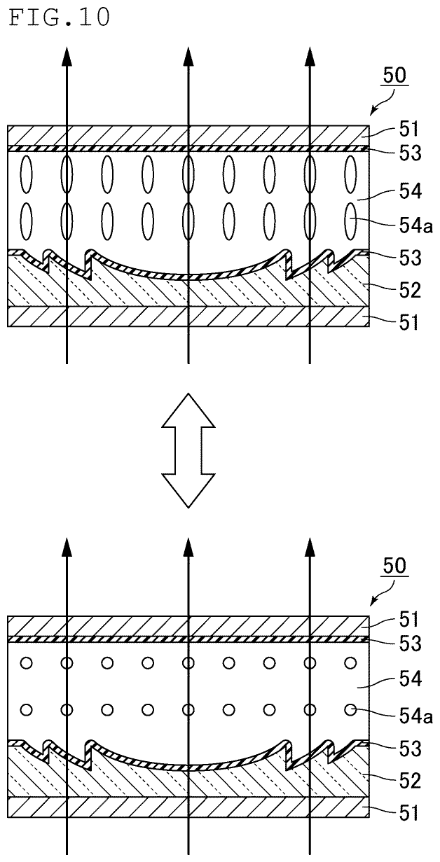

The refractive lenses are described with reference to FIGS. 8 to 10. FIG. 8 shows the structure of a refractive lens made of a resin, with the upper part showing a cross-sectional view and the lower part showing a top view. FIG. 9 shows the operation of the refractive lens at an azimuth A indicated in FIG. 8, with the upper part showing the state with voltage applied to the liquid crystal layer and the lower part showing the state with no voltage applied to the liquid crystal layer. FIG. 10 shows the operation of the refractive lens at an azimuth B indicated in FIG. 8, with the upper part showing the state with voltage applied to the liquid crystal layer and the lower part showing the state with no voltage applied to the liquid crystal layer. The arrows in FIGS. 9 and 10 indicate the paths of light transmitted through the refractive lens.

The refractive lens has a structure in which a glass substrate 51, a Fresnel lens 52 made of a resin, an electrode 53, a liquid crystal layer 54, an electrode 53, and a glass substrate 51 are laminated. For example, when the liquid crystal layer 54 includes a positive liquid crystal 54a (the major axes of the liquid crystal refractive index ellipsoids are oriented along the electric fields), the molecules of the liquid crystal 54a are aligned horizontally with no voltage applied (the lower parts of FIGS. 9 and 10) while the molecules of the liquid crystal 54a are aligned vertically with voltage applied (the upper parts of FIGS. 9 and 10). The combination of the refractive indices of the resin constituting the Fresnel lens 52 and the liquid crystal 54a is not limited. For example, the refractive index of the resin is set to about 1.5, ne (major axis refractive index) of the liquid crystal 54a is set to 1.8, and no (minor axis refractive index) of the liquid crystal 54a is set to 1.5. At this time, as shown in FIG. 9, at the azimuth A, the path of light is bent due to the refractive index difference with no voltage applied, and the path of light is not bent due to no refractive index difference with voltage applied. In contrast, as shown in FIG. 10, at the azimuth B, no refractive index difference arises both in the state with no voltage applied and in the state with voltage applied, so that the lens function is always not exerted.

The liquid crystal lens 50 may be a Pancharatnam-Berry phase lens. A Pancharatnam-Berry phase lens is a liquid crystal lens that can switch between the modes of divergence and convergence depending on the handedness of the circularly polarized light (e.g., U.S. Pat. No. 10,379,419 B). For example, the Pancharatnam-Berry phase lens functions as a lens whose focal length is switchable between f and −f for left-handed circularly polarized light and right-handed circularly polarized light. The focal length f of an active Pancharatnam-Berry phase lens can be controlled, in principle, by liquid crystal alignment period. In the present embodiment, a fixed lens with a focal length of f is added separately to change the focal lengths to be switched to enable focal length adjustment. Thus, adding a fixed lens with a focal length of f, for example, enables switching between a focal length of f/2 and a focal length of 0. Also, since circularly polarized light can be produced by adding a λ/4 plate to a linear polarizer, almost the same action can be exerted using almost the same configuration as in the case of linearly polarized light by adjusting the optical power of the lens separately added.

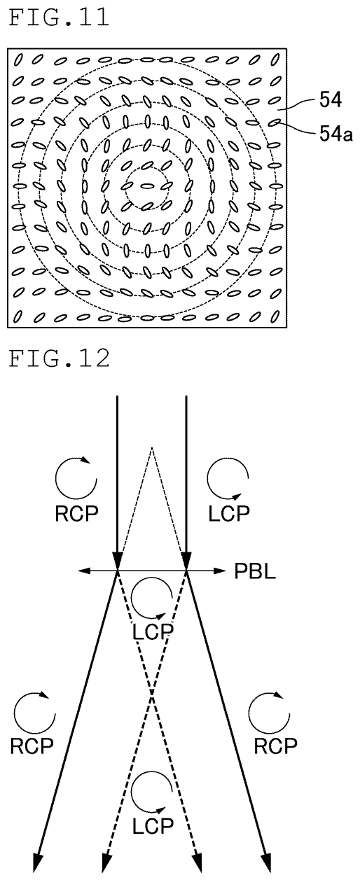

FIG. 11 is a top view showing the configuration of a Pancharatnam-Berry phase lens. FIG. 12 shows the functions of a Pancharatnam-Berry phase lens. The Pancharatnam-Berry phase lens uses a Pancharatnam-Berry phase (PB alignment) where the periodic molecular alignment of the liquid crystal 54a as shown in FIG. 11 causes diffraction to enable the lens function. In FIG. 12, the path of right-handed circularly polarized light RCP emitted from a Pancharatnam-Berry phase lens PBL is indicated by the solid line, and the path of left-handed circularly polarized light LCP emitted from the Pancharatnam-Berry phase lens PBL is indicated by the dotted line. The Pancharatnam-Berry phase lens PBL in FIG. 12 causes incident right-handed circularly polarized light RCP to converge while causing incident left-handed circularly polarized light LCP to diverge, and the handedness of circularly polarized light emerging from the lens is reversed. As described above, the Pancharatnam-Berry phase lens can switch between divergence and convergence at the focal point f by switching the handedness of the incident circularly polarized light.

The Pancharatnam-Berry phase lens (PB lens) is a lens that can change the refractive power thereof (concave/convex lenses), and thus allows active on/off switching in principle. In other words, adjusting the alignment pitch of the liquid crystal enables adjustment of the lens power. When a PB lens is used, in order to convert light emitted from the display 11 to circularly polarized light, for example, the polarizing plate 13 is a circularly polarizing plate including a linear polarizer and a λ/4 plate in combination. When the surface-divided polarization conversion component 20 which can convert circularly polarized light to the opposite-handed circularly polarized light is placed on the circularly polarizing plate, left-handed and right-handed circularly polarized lights can be switched.

The augmented reality display device of the present embodiment can switch between two virtual image planes using the surface-divided polarization conversion component 20. This allows the user to see two planes at different distances at the same time owing to the surface division to provide display with depth (3D display), thus enhancing the sense of immersion in the AR and allowing smooth gaze switching.

### Embodiment 2

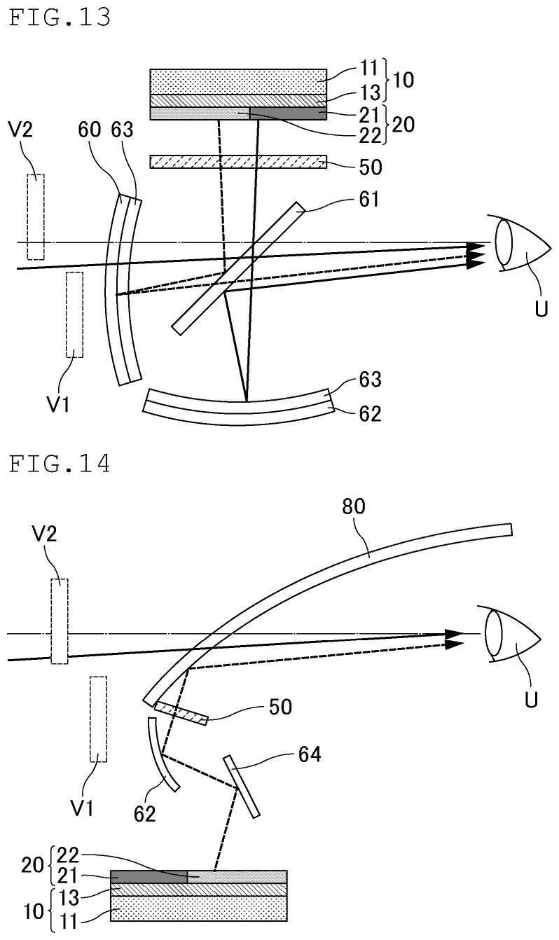

FIG. 13 is a side view schematically showing the configuration of an augmented reality display device of Embodiment 2. The augmented reality display device of Embodiment 2 is an AR display device having what is called a birdbath optical design. Owing to a polarization selective reflector 61 placed between the liquid crystal lens 50 and the concave semi-transparent mirror 60, the images are less likely to be distorted while a sufficient light use efficiency is achieved. In this configuration, the virtual image distances can be switched using the liquid crystal lens 50 or the distance of each virtual image V can be changed by changing the curvatures of the concave semi-transparent mirror 60 placed in front of the user U and a concave mirror 62 placed below the eyes of the user U. On the surface of each of the concave semi-transparent mirror 60 and the concave mirror 62 opposite to the polarization selective reflector 61, a λ/4 plate 63 is placed.

In the configuration shown in FIG. 13, simply removing the liquid crystal lens 50 and changing the curvature of the concave mirror 62 also enables two virtual image distances at the same time.

### Embodiment 3

An augmented reality display device of Embodiment 3 is a head-up display (abbreviated as HUD). The head-up display commonly uses a windshield or a semi-transparent surface called a combiner (often a spherical surface or a free-form surface close to a spherical surface) to superimpose images from the display on the real environment.

FIG. 14 is a side view schematically showing an augmented reality display device of Embodiment 3 and showing an optical design for HUDs using the windshield of a passenger car. A windshield 80 is a curved surface close to a spherical surface and thus has a slight effect of enlarging an image, which is however insufficient. The windshield 80 thus commonly includes a concave mirror 62 opposite to the side of the windshield 80 on which light is incident, so that the original image is enlarged owing to the effect of the combination.

There are some possible positions for the liquid crystal lens 50. Since the virtual image distances are determined as a result of extending the optical distances and ambient light should not enter the liquid crystal lens 50 (since ambient light also produces enlarged images), the liquid crystal lens 50 is preferably placed between the windshield 80 and the concave mirror 62 or in vicinity of the concave mirror 62.

Also, the liquid crystal lens 50 may be placed in front of the concave mirror 62 to about double the optical power of the liquid crystal lens 50. In this case, the refractive liquid crystal lens as shown in FIG. 8, whose optical power is different for different vibration directions of linearly polarized lights, can by itself about double the optical power. In the case of a PB lens as shown in FIG. 11, for example, a λ/4 plate 63 is placed as shown in FIG. 15 in consideration of the reversal of the handedness of circularly polarized light. FIG. 15 is a side view schematically showing another example of the configuration in the vicinity of a concave semi-transparent mirror in the augmented reality display device of Embodiment 3.

When such a configuration is used to divide a surface into a region with a phase difference of λ/2 and a region with a phase difference of zero (when a PB lens is used, a first region with a phase difference of λ/4 and a second region with its axis orthogonal to the axis of the first region and with a phase difference of λ/4), the images appear to float at different distances as indicated by virtual images V1 and V2. This enables use of (different) virtual image distances depending on the situation.

### Embodiment 4

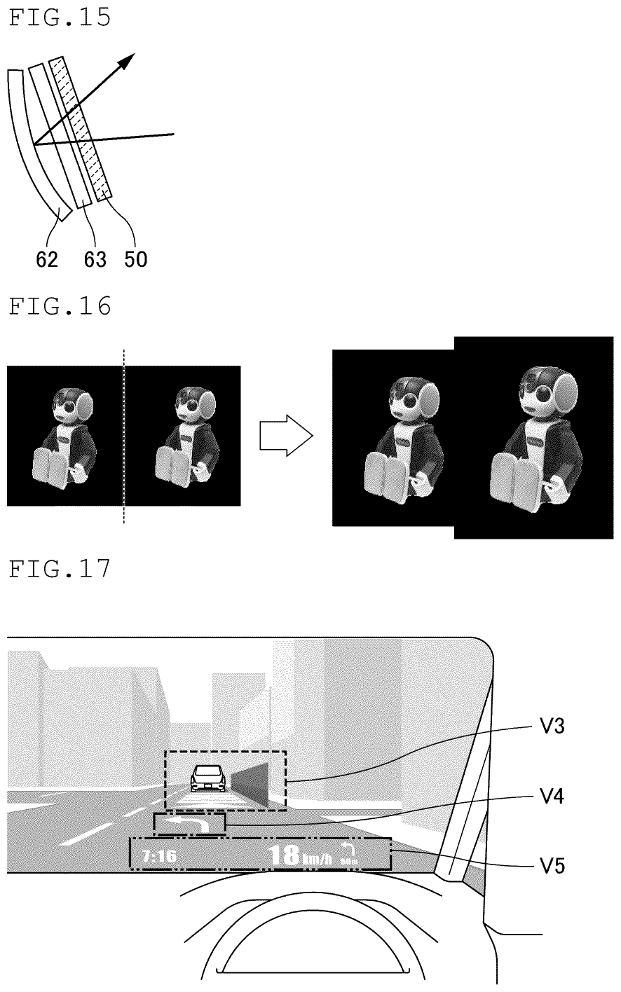

FIG. 16 is an explanatory view showing an example of images displayed by an augmented reality display device, with the left part showing the original image and the right part showing an enlarged image. FIG. 17 is an explanatory view showing an example in which display images displayed by an in-vehicle augmented reality display device are superimposed on the real environment. An augmented reality display device, which superimposes images on the real environment, has the following display features.
(1) As shown in FIG. 16, in providing display by an augmented reality display device, a portion with no image (black display portion) tends to be large.
(2) As shown in FIG. 17, in providing display by an augmented reality display device in many cases, virtual images superimposed on the real environment tend to be displayed at closer positions in the lower part of the screen and displayed at distant positions in the upper part of the screen. FIG. 17 shows a back virtual image V3 which is an AR image superimposed on the real environment in the upper part of the screen; a first front virtual image V4 which is an AR image generated in response to the car behavior in the center of the screen; and a second front virtual image V5 which is an AR image including a speedometer and the like in the lower part of the screen.

In consideration of the features above, an augmented reality display device presumably fixes the virtual images at distant positions in the upper part of the screen while fixing the virtual images at close positions in the lower part of the screen, so as to switch between the virtual image distances (virtual image positions) only in part of the screen. In this case, at least part of the surface-divided polarization conversion component is defined by a liquid crystal panel to enable switching between virtual image positions, and at least another part of the surface-divided polarization conversion component is defined by a phase difference plate to shift the phase by λ/2, so that a portion(s) where the virtual image distance is switched between the distant position and the close position and a portion(s) where the virtual image distances are fixed can respectively be provided.

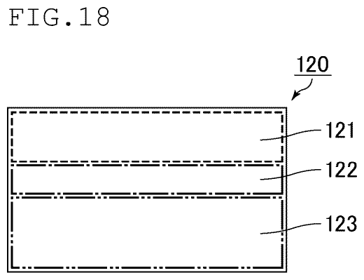

FIG. 18 is a plan view schematically showing the configuration of a surface-divided polarization conversion component in an augmented reality display device of Embodiment 4. As shown in FIG. 18, a surface-divided polarization conversion component 120 in a plan view includes a first transmissive part 121 which transmits polarized light for a first image, a second transmissive part 122 which transmits polarized light for a second image, and a third transmissive part 123 which transmits polarized light for a third image. The first transmissive part 121 includes no phase difference plate. The second transmissive part 122 includes a liquid crystal panel. The third transmissive part 123 includes a phase difference plate. The configuration of the surface-divided polarization conversion component 120 in FIG. 18 corresponds to a division example of the display screen of an augmented reality display device. In other words, the first transmissive part 121 corresponds to the upper part of the screen on which the virtual images are to be fixed at distant positions, the second transmissive part 122 corresponds to the center of the screen where the virtual image distances (virtual image positions) are switched, and the third transmissive part 123 corresponds to the lower part of the screen on which the virtual images are fixed at close positions.

The third transmissive part 123 can be formed at low cost by attaching a phase difference plate. Yet, the liquid crystal panel defining the second transmissive part 122 may be increased in size to also form the third transmissive part 123 with the liquid crystal panel. The liquid crystal panel can suitably be one using a liquid crystal whose molecules are horizontally aligned with no voltage applied. In any case, the first transmissive part 121 does not requires a liquid crystal panel or a phase difference plate. Thus, the surface-divided polarization conversion component 120 of Embodiment 4 can be produced at lower cost than surface-divided polarization conversion components capable of switching between the virtual image distances on the entire screen.

### Modified Example 1

The augmented reality display devices of Embodiments 1 and 2 each use one set of a surface-divided polarization conversion component and a liquid crystal lens. Yet, the augmented reality display devices of Embodiments 1 and 2 may each include multiple sets of the surface-divided polarization conversion component 20 and the liquid crystal lens 50. Use of multiple sets (N sets) enables production of 2^{N} virtual image planes. The use, however, complicates driving and the later-described image processing, for example.

The surface-divided polarization conversion component 20 is better to be placed close to the display surface in principle. This is because the boundary between virtual images V can be clearly defined on the display image. When the surface-divided polarization conversion component 20 is moved away from the display surface, the pixels in the boundary may be included in both of the two virtual image planes. This boundary problem can be resolved by using the later-described image processing or other technique in combination.

As described above, use of multiple sets of the surface-divided polarization conversion component 20 and the liquid crystal lens 50 enables switching among 2^{N} virtual image planes. Thus, the user can view 2^{N} planes at different distances at the same time owing to the surface division and thus display with depth (3D display). This can enhance the sense of immersion as VR and allows smooth gaze switching.

### Modified Example 2

Although the embodiments above use a voltage-variable liquid crystal lens, a static (invariable) liquid crystal lens 50 made of a UV-cured liquid crystal material may be used. In this case, since a static liquid crystal lens 50 is used, the virtual image V cannot be moved by voltage, but two virtual images (including cases of real images) V can be switched by the surface-divided polarization conversion component 20.

Thus, this embodiment is advantageous in that the production is possible at low cost, and the electrically conductive lines are gathered in the display 11 as the liquid crystal lens 50 requires no electrically conductive lines.

### REFERENCE SIGNS LIST

10: display panel
11: display
13: polarizing plate
20, 120: surface-divided polarization conversion component
21: conversion part
22: non-conversion part
25: substrate
26: liquid crystal layer
26a: liquid crystal
40: lens (physical lens)
50: liquid crystal lens
51: glass substrate
52: Fresnel lens
53: electrode
54: liquid crystal layer
54a: liquid crystal
60: concave semi-transparent mirror
61: polarization selective reflector
62: concave mirror
63: λ/4 plate
64: mirror
80: windshield
121: first transmissive part
122: second transmissive part
123: third transmissive part
D1: focus adjustment distance
D2: convergence distance
I1, I2: 3D image
I2a: blurred image
R: image intended for the right eye
RCP: right-handed circularly polarized light
RE: right eye
L: image intended for the left eye
LCP: left-handed circularly polarized light
LE: left eye
U: user (viewer)
V, V1, V2: virtual image
V3: back virtual image
V4: first front virtual image
V5: second front virtual image

What is claimed is:

1. An augmented reality display device causing a user to perceive a first image and a second image at different distances in a state where the user can perceive a real environment, the augmented reality display device comprising:
a display panel configured to emit polarized light for a first image and polarized light for a second image;
a surface-divided polarization conversion component placed at a position where the polarized lights enter; and
an optical element and a concave semi-transparent mirror, each being placed at a position where the polarized lights transmitted through the surface-divided polarization conversion component enter,
the surface-divided polarization conversion component in a plan view including:
a first transmissive part which transmits polarized light for a first image; and
a second transmissive part which transmits polarized light for a second image and introduces a phase difference different by λ/2 from a phase difference introduced by the first transmissive part,
the optical element being configured to make a virtual image distance of a first image generated from the first polarized light transmitted through the first transmissive part different from a virtual image distance of a second image generated from the second polarized light transmitted through the second transmissive part.

2. The augmented reality display device according to claim 1,
wherein the first transmissive part is a non-conversion part that transmits polarized light for a first image without converting a polarization state of the polarized light, and
the second transmissive part is a conversion part that converts a polarization state of polarized light for a second image by introducing a phase difference of λ/2 to the polarized light for a second image.

3. The augmented reality display device according to claim 2,
wherein the conversion part includes a resin layer with a phase difference of λ/2.

4. The augmented reality display device according to claim 1,
wherein the second transmissive part in a cross-sectional view includes a pair of substrates and a liquid crystal layer placed between the pair of substrates, and
the second transmissive part introduces a phase difference that is variable depending on voltage applied to the liquid crystal layer.

5. The augmented reality display device according to claim 1,
wherein the optical element is a liquid crystal lens, and
the liquid crystal lens acts as a lens with a first focal length for the first polarized light and does not act as a lens or acts as a lens with a second focal length for the second polarized light.

6. The augmented reality display device according to claim 5,
wherein the liquid crystal lens is a refractive lens, a gradient-index lens, or a diffractive lens.

7. The augmented reality display device according to claim 5,
wherein the liquid crystal lens is a Pancharatnam-Berry phase lens.

8. The augmented reality display device according to claim 5,
wherein the liquid crystal lens includes a liquid crystal layer and has a focal length that is variable depending on voltage applied to the liquid crystal layer.

9. The augmented reality display device according to claim 1, further comprising a polarization selective reflector placed at a position where the polarized lights transmitted through the surface-divided polarization conversion component enter.

10. The augmented reality display device according to claim 1, further comprising a combination of an additional surface-divided polarization conversion component and an additional liquid crystal lens.

11. The augmented reality display device according to claim 1, which is a head-mounted display device.
